(19) United States
(12) Patent Application Publication
(10) Pub. No.: US 2007/0056325 A1
(43) Pub. Date: Mar. 15, 2007

(54) Optical article and molding assembly for making the same

(75) Inventor: Kun-Chih Wang, Tan-Tzu Hsiang (TW)

Correspondence Address: BANNER & WITCOFF, 1001 G STREET N W, SUITE 1100, WASHINGTON, DC, 20001, US

(73) Assignee: Asia Optical Co., Inc., T.E.P.Z. (TW)

(21) Appl. No.: 11/451,458

(22) Filed: Jun. 13, 2006

(30) Foreign Application Priority Data
Sep. 13, 2005 (TW) 094131518

(51) Int. Cl. C03B 11/00

(52) U.S. Cl. 65/305; 425/395; 425/808

(57) ABSTRACT

An optical article includes a glass sheet having a top surface, a bottom surface, an array of optical elements formed between the top and bottom surfaces and arranged in rows that intersect each other along two intersecting cutting directions of the glass sheet, and at least two aligning marks formed on one of the top and bottom surfaces and spaced apart from each other in one of the cutting directions. A molding assembly for making the optical article is also disclosed.

### CROSS-REFERENCE TO RELATED APPLICATION

This application claims priority of Taiwanese Application No. 094131518, filed on Sep. 13, 2005.

### BACKGROUND OF THE INVENTION

1. Field of the Invention

The invention relates to an optical article, more particularly to an optical article formed with an array of optical elements. The invention also relates to a molding assembly for making the optical article.

2. Description of the Related Art

Referring to FIG. 1, U.S. patent application Publication No. 2003/0115907 A1 discloses a multiple lens molding system and method. The system includes a master die 1 having an inner surface 101 formed with a plurality of convex protrusions 102. A molding die 2 is formed from a transfer material using the master die 1. The molding die 2 has an inner surface 201 formed with a plurality of molding recesses 202 complementary to the convex protrusions 102. A moldable sheet 3, such as a glass sheet, is disposed on the inner surface 201 of the molding die 2. Heat and pressure are applied to the moldable sheet 3 so that the moldable sheet 3 is pressed into the molding recesses 202 of the molding die 2 to obtain a unitary molded sheet 4 formed with a plurality of lens elements 401. The unitary molded sheet 4 is diced to obtain a plurality of lens elements 401. Although the aforesaid system can make a plurality of the lens elements 401 at the same time from a unitary moldable sheet 3 using the molding die 2, the following disadvantages are encountered:

1. Since the master die 1 is required to make the molding die 2, the molding method of the prior art is complicated and inconvenient.

2. Since the unitary molded sheet 4 has no aligning mark, the unitary molded sheet 4 cannot be diced precisely.

3. Since the molding recesses 202 are integrated with the molding die 2, the molding die 2 should be reproduced if one or some of the molding recesses 202 are damaged, thereby increasing the production cost.

4. When the moldable sheet 3 is increased in its size, the molding die 2 should be increased in its size accordingly. However, it is relatively difficult to form the molding recesses 202 of the molding die 2 precisely when the size of the molding die 2 is increased.

### SUMMARY OF THE INVENTION

An object of the present invention is to provide an optical article which can be cut precisely to obtain a plurality of optical elements.

Another object of the present invention is to provide a molding assembly for making the optical article.

Therefore, in one aspect of this invention, an optical article includes a glass sheet having a top surface, a bottom surface, an array of optical elements formed between the top and bottom surfaces and arranged in rows that intersect each other along two intersecting cutting directions of the glass sheet, and at least two aligning marks formed on one of the top and bottom surfaces and spaced apart from each other in one of the cutting directions.

In another aspect of this invention, a molding assembly for making an optical article, which includes a glass sheet formed with an array of optical elements arranged in rows intersecting each other along two intersecting cutting directions of the glass sheet, and at least two spaced apart aligning marks formed on the glass sheet in one of the cutting directions, includes a first mold unit and a second mold unit. The first mold unit includes a first mold plate, an array of first mold cores mounted in the first mold plate, and at least two first mark molding cores mounted in the first mold plate along one of the cutting directions. The first mold cores respectively have first element molding surfaces. Each of the first mark molding cores has a first mark molding surface. The second mold unit includes a second mold plate, and an array of second mold cores mounted in the second mold plate and alignable with the first mold cores, respectively. The second mold cores respectively have second element molding surfaces.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic sectional view to illustrate consecutive steps of a conventional multiple lens molding method disclosed in U.S. patent application Publication No. 2003/0115907 A1;

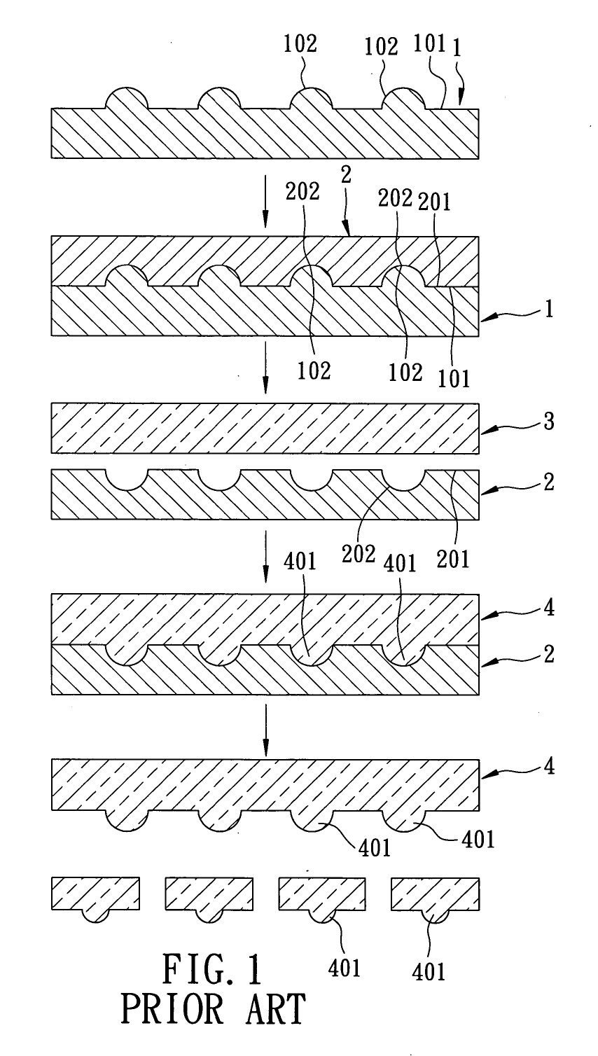

FIG. 2 is a sectional view of the preferred embodiment of a molding assembly according to this invention;

FIG. 3 is a schematic view of a mold unit used in the preferred embodiment of the molding assembly;

FIG. 4 is a sectional view of the preferred embodiment of the molding assembly in a state of molding a glass sheet into an optical article;

FIG. 5 is a sectional view of the preferred embodiment of the optical article according to this invention;

FIG. 6 is a schematic view of the preferred embodiment of the optical article; and

FIG. 7 is a sectional view to illustrate the optical article in a state of cutting it into a plurality of optical elements.

### DETAILED DESCRIPTION OF THE PREFERRED EMBODIMENT

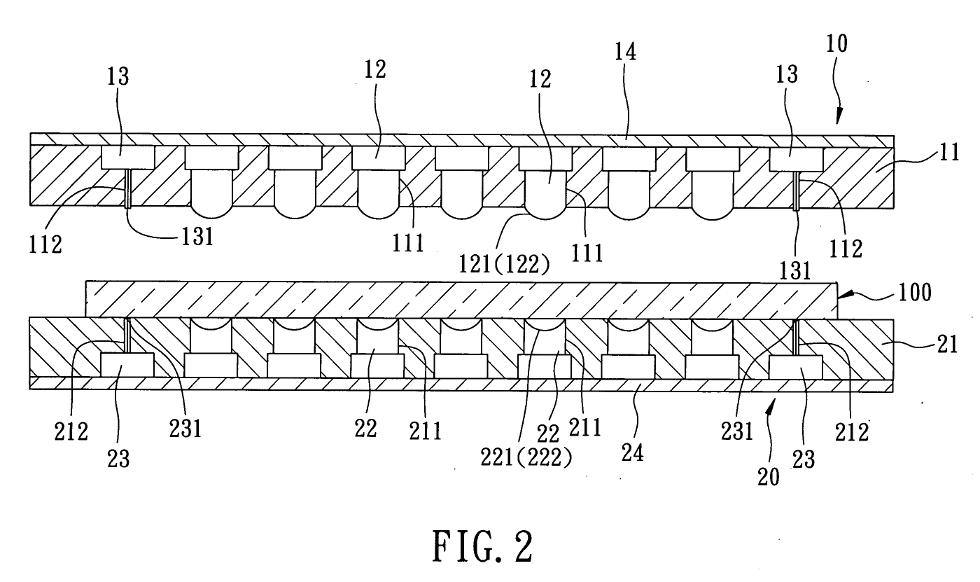

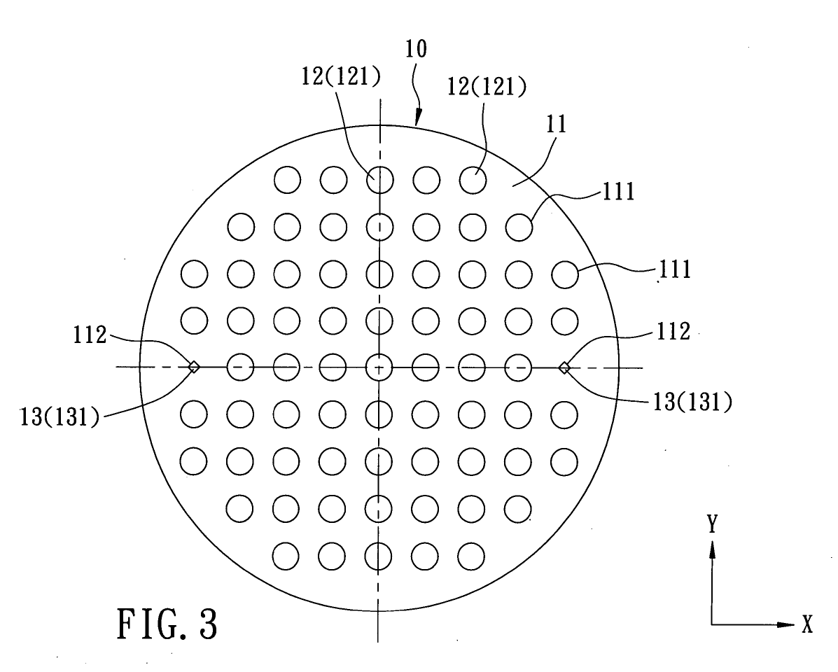

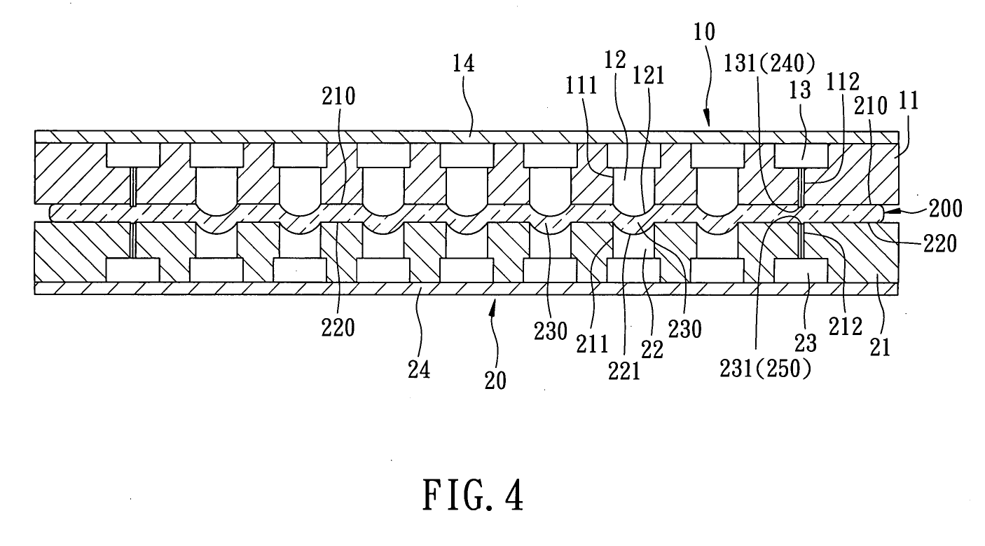

Referring to FIGS. 2, 3, and 4, the preferred embodiment of the molding assembly according to this invention is shown to be suited for making an optical article which includes a glass sheet 200 formed with an array of optical elements 23.0 arranged in rows that intersect each other along two intersecting cutting directions (X, Y) of the glass sheet 200, and four spaced apart aligning marks 240, 250 formed on the glass sheet 200 in one of the cutting directions (X). The molding assembly includes a first mold unit 10 and a second mold unit 20.

The first mold unit 10 is movable upward and downward relative to the second mold unit 20, and includes a first mold plate 11, an array of first mold cores 12 mounted in the first mold plate 11 and arranged in rows intersecting each other along the two cutting directions (X, Y), two first mark molding cores 13 mounted in the first mold plate 11 along one of the cutting directions (X), and a first fixing plate 14. The first mold cores 12 respectively have first element molding surfaces 121. Each of the first mark molding cores 13 has a first mark molding surface 131, which has a substantially rhombic periphery.

The first mold plate 11 has an array of first receiving holes 111 formed in rows along the two intersecting cutting directions (X, Y) for receiving the first mold cores 12, respectively, and two second receiving holes 112 formed along one of the cutting directions (X) for receiving the first mark molding cores 13, respectively. The first fixing plate 14 is stacked on the first mold plate 11 opposite to the first element molding surfaces 121 and blocks the first and second receiving holes 111, 112. The first mold plate 11 has a substantially circular cross section. The first mark molding cores 13 are aligned with a center of the first mold plate 11 and are symmetric to each other relative to the center. Each of the first mold cores 12 further has a protective film 122 formed on the first element molding surface 121. In this preferred embodiment, the protective film 122 can be a diamond film, a carbon film, a film containing one or more of Pt, Ir, Re, Ru, Cr, Ni, Al, Ti, W, and Mo or a compound thereof, and the like.

The second mold unit 20 includes a second mold plate 21, an array of second mold cores 22 mounted in the second mold plate 21 and alignable with the first mold cores 12, respectively, two second mark molding cores 23 mounted in the second mold plate 21 and alignable with the first mark molding cores 13, respectively, and a second fixing plate 24. The second mold cores 22 respectively have second element molding surfaces 221. Each of the second mark molding cores 23 has a second mark molding surface 231, which has a substantially rhombic periphery. The second mold plate 21 has an array of third receiving holes 211 respectively corresponding to the first receiving holes 111 of the first mold plate 11 for receiving the second mold cores 22, respectively, and two fourth receiving holes 212 corresponding to the second receiving holes 112 of the first mold plate 11 for receiving the second mark molding cores 23, respectively. The second fixing plate 24 is stacked on the second mold plate 21 opposite to the second element molding surfaces 221, and blocks the third and fourth receiving holes 211, 212. Each of the second mold cores 22 further has a protective film 222 formed on the second element molding surface 221. In this preferred embodiment, the material for the protective film 222 of each of the second mold cores 22 is identical to that for the protective film 122 of each of the first mold cores 12.

Referring to FIGS. 2, 4, and 5, in a chamber (not shown), a glass material 100 is disposed on the second mold unit 20, and is heated together with the first and second mold units 10, 20 directly (e.g., by resistance heating) or indirectly (e.g., by infra-red heating) so as to soften the glass material 100. The first mold unit 10 is moved toward the second mold unit 20 so as to press the glass material 100 into the glass sheet 200, which is formed with an array of the optical elements 230 and four aligning marks 240, 250. Each of the optical elements 230 is molded by one of the first element molding surfaces 121 and a corresponding one of the second element molding surfaces 221. Each of the optical elements 230 is an optical lens. Each of the aligning marks 240 on a top surface 210 of the glass sheet 200 is molded by the first mark molding surface 131 of a corresponding one of the first mark molding cores 13. Each of the aligning marks 250 on a bottom surface 220 of the glass sheet 200 is molded by the second mark molding surface 231 of a corresponding one of the second mark molding cores 23.

When the first and second mold units 10, 20 and the glass sheet 200 are cooled, the first mold unit 10 is moved away from the second mold unit 20 so as to permit removal of the glass sheet 200 from the second mold unit 20 and to obtain the optical article.

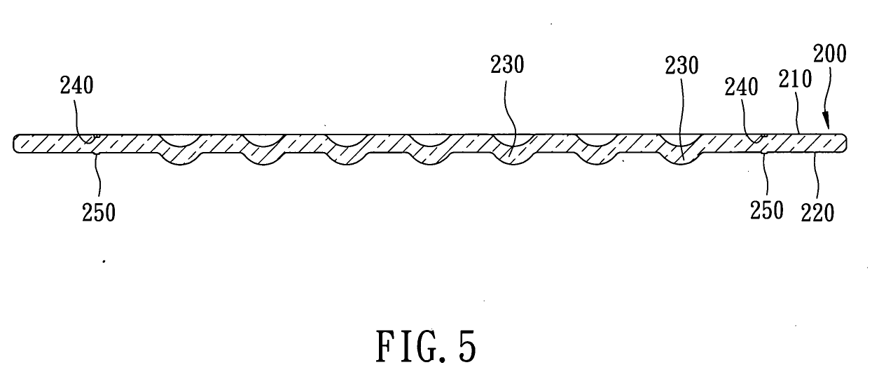

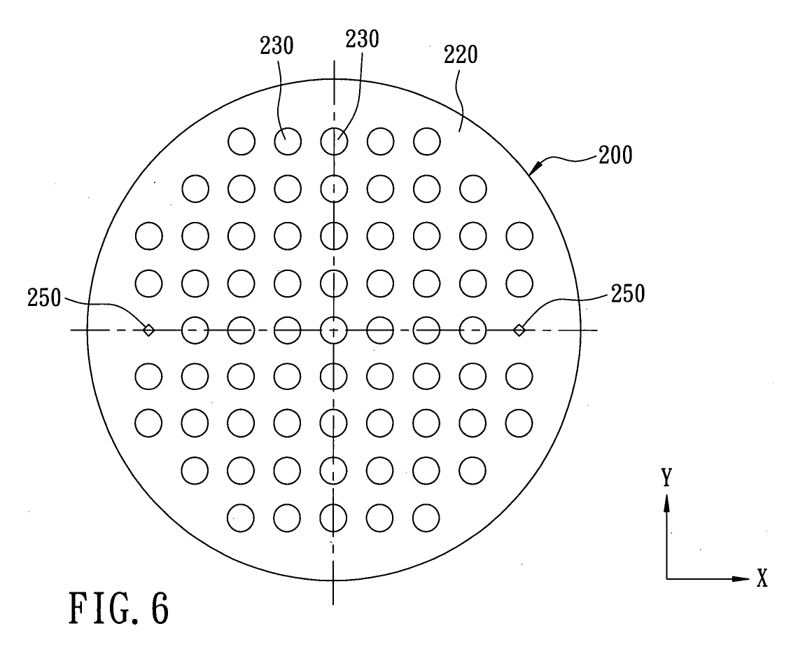

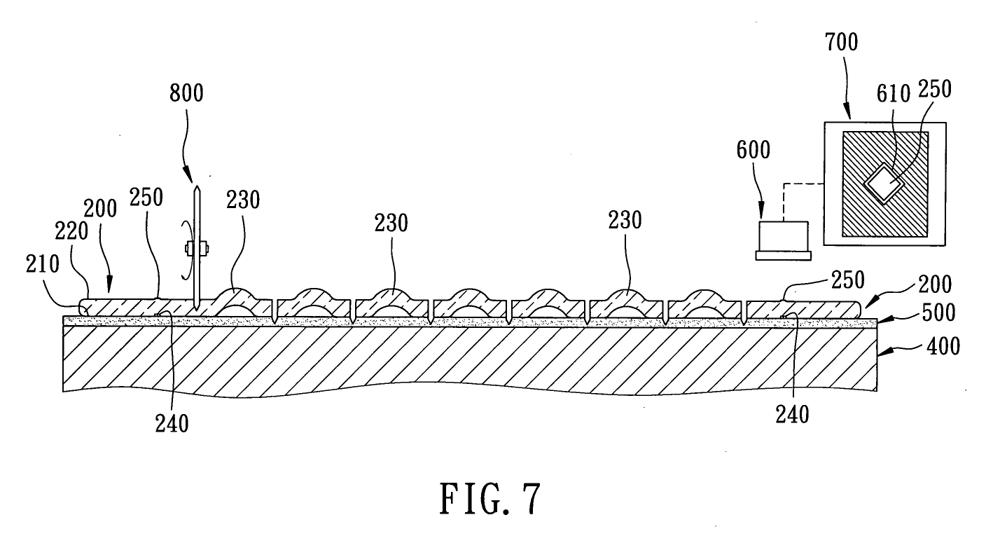

Referring to FIGS. 5 and 6, therefore, the optical article includes the glass sheet 200 having the top surface 210, the bottom surface 220, an array of the optical elements 230 formed between the top and bottom surfaces 210, 220 and arranged in rows intersecting each other along the two intersecting cutting directions (X, Y) of the glass sheet 200, and four aligning marks 240, 250. In this preferred embodiment, the cutting directions (X, Y) are perpendicular to each other. Two of the aligning marks 240 are formed on the top surface 210 and are spaced apart from each other in one of the cutting directions (X). The other two of the aligning marks 250 are formed on the bottom surface 220, are spaced apart from each other in one of the cutting directions (X), and are aligned with the two aligning marks 240, respectively. Furthermore, the glass sheet 200 has a substantially circular cross section. The aligning marks 240 on the top surface 210 of the glass sheet 200 are aligned with a center of the glass sheet 200 and are symmetric to each other relative to the center. Identically, the aligning marks 250 on the bottom surface 220 of the glass sheet 200 are aligned with the center and are symmetric to each other relative to the center. Referring to FIGS. 6 and 7, the glass sheet 200 is fixed on a work table 400 of a cutting machine (not shown) using a UV tape 500. The work table 400 is controlled by a computer (not shown). Each of the aligning marks 250 is captured by a CCD camera 600. The work table 400 is then adjusted so as to align each of the aligning marks 250 with a corresponding reference mark 610 of the CCD camera 600 shown on a screen 700. After the aligning operation, the glass sheet 200 is cut by a cutting tool 800 along the cutting directions (X, Y) so as to obtain a plurality of the optical elements 230. The optical elements 230 can be removed from the work table 400 by exposing the UV-tape 500 to UV-light. Notably, when the optical elements 230 to be produced are convex lenses, the first element molding surfaces 121 of the first mold unit 10 and the second element molding surfaces 221 of the second mold unit 20 are formed as a recess configuration, and thus should be vacuumed to remove residual gas therein prior to the molding procedure. Although the optical elements 230 illustrated in the preferred embodiment are optical lenses, other optical elements, such as micro lenses, micro lens array, diffractive optical elements, and the like, can be made using the first and second mold cores 12, 22 having appropriate configurations.

In view of the aforesaid, this invention has the following advantages:

1. The glass sheet 200 formed with a plurality of optical elements 230 can be made from the unitary glass material 100. Therefore, a plurality of the optical elements 230 can be made at the same time, and the productivity is increased significantly as compared to a conventional technology in which a single optical element is made from a single glass material.

2. As compared to the multiple lens molding system and method disclosed in the U.S. patent application Publication No. 2003/0115907 A1 in which the master die 1 is required to make the molding die 2, the optical article formed with a plurality of the optical elements 230 can be made simply and conveniently.

3. Since the glass sheet 200 is provided with the aligning marks 240, 250, the cutting step can be carried out simply and precisely.

4. Since the first and second mold cores 12, 22 are made individually and are separable from the first and second mold plates 11, 21, respectively, the first or second mold cores 12, 22, when damaged, can be replaced with new ones.

5. When the size of the glass sheet 200 to be produced is increased, it is only needed to replace the first and second mold plates 11, 21 with those having a larger size.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An optical article, comprising:
a glass sheet having a top surface, a bottom surface, an array of optical elements formed between said top and bottom surfaces and arranged in rows that intersect each other along two intersecting cutting directions of said glass sheet, and at least two aligning marks formed on one of said top and bottom surfaces and spaced apart from each other in one of said cutting directions.

2. The optical article as claimed in claim 1, wherein said two cutting directions are perpendicular to each other.

3. The optical article as claimed in claim 1, wherein said optical article has four aligning marks, two of said aligning marks being formed on said top surface and being spaced apart from each other along said one of said cutting directions, the other two of said aligning marks being formed on said bottom surface and being aligned with said two of said aligning marks, respectively.

4. The optical article as claimed in claim 1, wherein said glass sheet has a substantially circular cross section, said aligning marks being aligned with a center of said glass sheet and being symmetric to each other relative to said center.

5. The optical article as claimed in claim 1, wherein each of said optical elements is an optical lens.

6. A molding assembly for making an optical article which includes a glass sheet formed with an array of optical elements arranged in rows that intersect each other along two intersecting cutting directions of the glass sheet, and at least two spaced apart aligning marks formed on the glass sheet in one of the cutting directions, said molding assembly comprising:
a first mold unit including a first mold plate, an array of first mold cores mounted in said first mold plate, and at least two first mark molding cores mounted in said first mold plate along one of the cutting directions, said first mold cores respectively having first element molding surfaces, each of said first mark molding cores having a first mark molding surface; and
a second mold unit including a second mold plate, and an array of second mold cores mounted in said second mold plate and alignable with said first mold cores, respectively, said second mold cores respectively having second element molding surfaces.

7. The molding assembly as claimed in claim 6, wherein said second mold unit further includes at least two second mark molding cores mounted in said second mold plate and alignable with said first mark molding cores, respectively, each of said second mark molding cores having a second mark molding surface.

8. The molding assembly as claimed in claim 7, wherein said first mold unit further includes a first fixing plate stacked on said first mold plate opposite to said first element molding surfaces, said first mold plate having an array of first receiving holes receiving said first mold cores, respectively, and at least two second receiving holes receiving said first mark molding cores, respectively, said first fixing plate blocking said first and second receiving holes.

9. The molding assembly as claimed in claim 8, wherein said second mold unit further includes a second fixing plate stacked on said second mold plate opposite to said second element molding surfaces, said second mold plate having an array of third receiving holes receiving said second mold cores, respectively, and at least two fourth receiving holes receiving said second mark molding cores, respectively, said second fixing plate blocking said third and fourth receiving holes.

10. The molding assembly as claimed in claim 6, wherein said first mold cores are arranged in rows that intersect each other along two perpendicularly intersecting lines parallel to the two intersecting cutting directions of the glass sheet, respectively.

11. The molding assembly as claimed in claim 10, wherein said first mold plate has a substantially circular cross section, said first mark molding cores being aligned with a center of said first mold plate and being symmetric to each other relative to said center.

12. The molding assembly as claimed in claim 6, wherein each of said first mold cores further has a protective film formed on said first element molding surface, each of said second mold cores further having a protective film formed on said second element molding surface.
